(19) United States
(12) Patent Application Publication
(10) Pub. No.: US 2025/0282062 A1
(43) Pub. Date: Sep. 11, 2025

(54) End Effector

(71) Applicant: Block One Automation, LLC, Fort Collins, CO (US)

(72) Inventor: Jonathan O’Neil, Fort Collins, CO (US)

(73) Assignee: Block One Automation, LLC, Fort Collins, CO (US)

(21) Appl. No.: 19/037,755

(22) Filed: Jan. 27, 2025

Related U.S. Application Data
(63) Continuation-in-part of application No. 18/600,020, filed on Mar. 8, 2024.

(51) Int. Cl. B25J 15/06

(52) U.S. Cl. CPC B25J 15/0616

(57) ABSTRACT

Generally, an end effector adapted to engage and move an object from a first location to a second location. Specifically, an end effector including one or more of a vacuum pad movable on the upright mast to engage an object top, a vacuum gripper movable on an upright mast to engage an object side, and a support plate extendable in relation to the upright mast to engage an object bottom, the end effector can be moved to correspondingly move the object.

This United States patent application is a continuation-in-part of U.S. patent application Ser. No. 18/600,020, filed Mar. 8, 2024, hereby incorporated by reference herein.

### I. FIELD OF THE INVENTION

Generally, an end effector adapted to engage and move an object from a first location to a second location. Specifically, an end effector including one or more of: an upright mast, a vacuum pad movable on the upright mast to engage an object top, a gripper movable on an upright mast to engage an object side, and a support plate extendable in relation to the upright mast to engage an object bottom, the end effector can be moved to correspondingly move the object.

### II. BACKGROUND OF THE INVENTION

Products can be accumulated and packed into cases or carrier trays (also referred to as a “pack”). The packs can be stacked, and generally a plurality of packs can be stacked onto pallets. The cases or carrier trays in which products are accumulated can be comparatively light and insubstantial compared to the weight of the products contained in the cases or carrier trays. In certain instances, the cases or carrier trays can be so flimsy that the conventional method of picking or other movement of products accumulated in the cases or carrier trays can be only by hand and not by machine.

As an illustrative example, canned products can be accumulated in carrier trays in which the height of the cans exceeds the height of the carrier tray sidewalls. Therefore, a portion of can sides and can tops can remain uncovered and unprotected by the carrier tray. A specific example is beer or soda cans accumulated in a 24 can cardboard carrier tray measuring 10⅝ inches×15½ inches×2¾ inches deep. The cans accumulated in the carrier tray can have a can height of between about 3⅝ inches to 5 inches and extend upward outside of the carrier tray sidewall.

Palletized cases and carrier trays can pose substantial problems for and can preclude machine handling. In the instance of carrier cases and trays, the bottom of the case or carrier tray can be difficult to engage with a lift without damaging the top of an underlying case or the unprotected can tops in an underlying carrier tray. Additionally, upon lifting of a carrier tray, unless the lifting force on the carrier tray supports the carrier tray bottom, the upper portion of the cans can shift to the extent that the carrier tray distorts which can result in the carrier tray disengaging from a machine or the cans falling away from the carrier tray.

Therefore, movement of cases and carrier trays containing accumulated product may still be moved by hand and not by machine, such as, a manual mechanical lift or by automaton or robot. Moving cases and carrier trays by hand can involve the corresponding inefficiencies in time and labor. Therefore, there would be a substantial advantage in provision of an end effector, a method of making an end effector, and a method of using an end effector adapted to or configured to move cases or carrier trays and in particular cases or carrier trays stacked onto pallets which would otherwise be moved by hand.

### III. SUMMARY OF THE INVENTION

Accordingly, a broad object of particular embodiments of the invention can be to provide an end effector, including one or more of: an upright mast, a vacuum pad movably coupled to the upright mast, wherein the vacuum pad has a vacuum pad face configured to engage a pack top, a vacuum gripper movably coupled to the mast, wherein the vacuum gripper has gripper face configured to engage a pack side, and a support plate extendable in relation to the upright mast, wherein the support plate has a support plate face configured to engage a pack bottom. The end effector can be operated to perform one or more of: engage the vacuum pad to engage a pack top, engage the vacuum gripper to engage the pack side and upwardly move vacuum pad or the vacuum gripper along the upright mast to lift the pack bottom away from an underlying pack, and engage the support plate with the pack bottom. The end effector can be subsequently moved from a first location to a second location to correspondingly move the pack engaged by the end effector from the first location, which can be a first pallet, to the second location, which can be a second pallet.

Another broad object of particular embodiments of the invention can be to provide a method of making an end effector, including one or more of: providing an upright mast, movably coupling a vacuum pad to the upright mast, wherein the vacuum pad has a vacuum pad face configured to engage a pack top, moveably coupling a vacuum gripper to the upright mast, wherein the vacuum gripper has vacuum gripper face configured to engage a pack side, extendably retractably coupling a support plate in relation to the upright mast, wherein the support plate has a support plate face configured to engage a pack bottom, and configuring the end effector to couple to a movement machine, such as an automaton or robot, whereby the configuration of the end effector allows performance of one or more of: the vacuum pad to engage the pack top and upwardly move along the upright mast to upwardly lift a pack from an underlying pack, the vacuum gripper to engage a pack side and upwardly move along the upright mast to lift a portion of the pack bottom from a pack top of an underlying pack, the support plate to extend in relation to the mast to engage a pack bottom. The end effector coupled to a movement machine, automaton, or robot can move the pack from a first location to a second location.

Another broad object of particular embodiments can be to provide a method of using an end effector including one or more of: moving an end effector proximate a pack and operating the end effector to perform one or more of: engage a vacuum pad to a pack top, engage a vacuum gripper to a pack side, move the vacuum pad and/or the vacuum gripper upward on an upright mast to lift the pack or a portion of a pack bottom of a pack away from a unlaying pack top, extend a support plate in relation to the mast to engage the pack bottom lifted by the vacuum pad and/or the vacuum gripper, and operating a machine, automaton or robot to move the end effector to correspondingly move the pack from a first location to a second location.

Naturally, further objects of the invention are disclosed throughout other areas of the specification, drawings, photographs, and claims.

### IV. BRIEF DESCRIPTION OF THE DRAWINGS

FIG. 1 is a top front perspective view of a particular embodiment of the inventive end effector.

FIG. 2 is a rear bottom perspective view of a particular embodiment of the inventive end effector.

FIG. 3 is a front elevation view of a particular embodiment of the inventive end effector.

FIG. 4 is rear elevation view of a particular embodiment of the inventive end effector.

FIG. 5 is a first side elevation view of a particular embodiment of the inventive end effector.

FIG. 6 is a second side elevation view of a particular embodiment of the inventive end effector.

FIG. 7 is a top plan view of a particular embodiment of the inventive end effector.

FIG. 8 is a bottom plan view of a particular embodiment of the inventive end effector.

FIG. 9 A is a cross section view 9A-9A depicted in FIG. 8 a particular embodiment of the inventive end effector.

FIG. 9 B is a cross section view 9B-9B depicted in FIG. 8 a particular embodiment of the inventive end effector.

FIG. 10 illustrates operating a particular embodiment of the inventive end effector to engage a gripper to a pack side.

FIG. 11 illustrates operating a particular embodiment of the inventive end effector to move the gripper upward on a mast to lift a portion of a pack bottom.

FIG. 12 illustrates operating a particular embodiment of the inventive end effector to extend a support plate in relation to said mast to support said package bottom lifted by said gripper.

FIG. 13 illustrates operating a particular embodiment of the inventive end effector to lower said compressor arm to engage a pack top.

FIG. 14 illustrates operating a particular embodiment of the inventive end effector to move a pack from a first location to a second location.

FIG. 15 is a block flow diagram of a method of using a particular embodiment of the inventive end effector to move a pack from a first location to a second location.

### V. DETAILED DESCRIPTION OF THE INVENTION

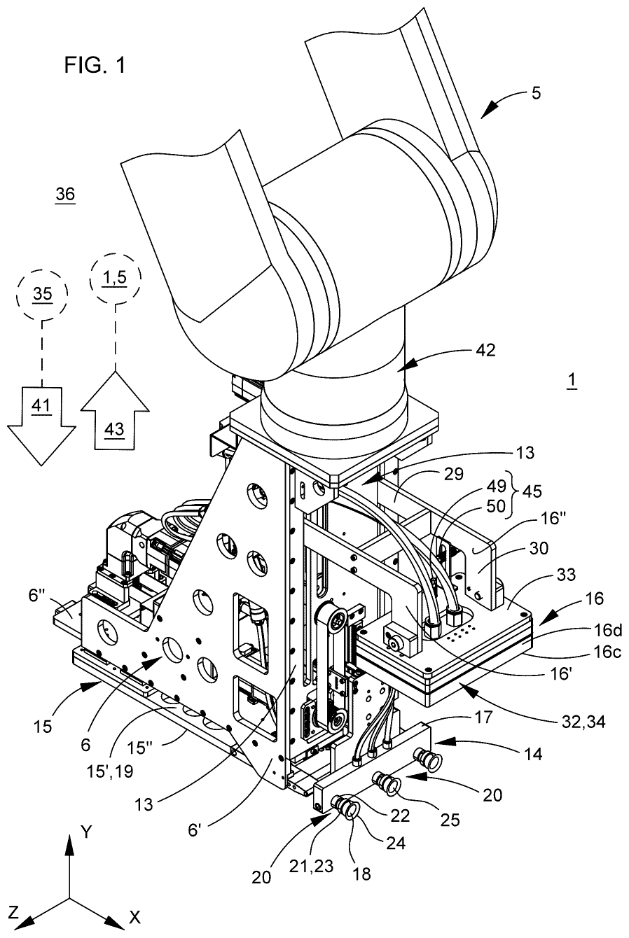

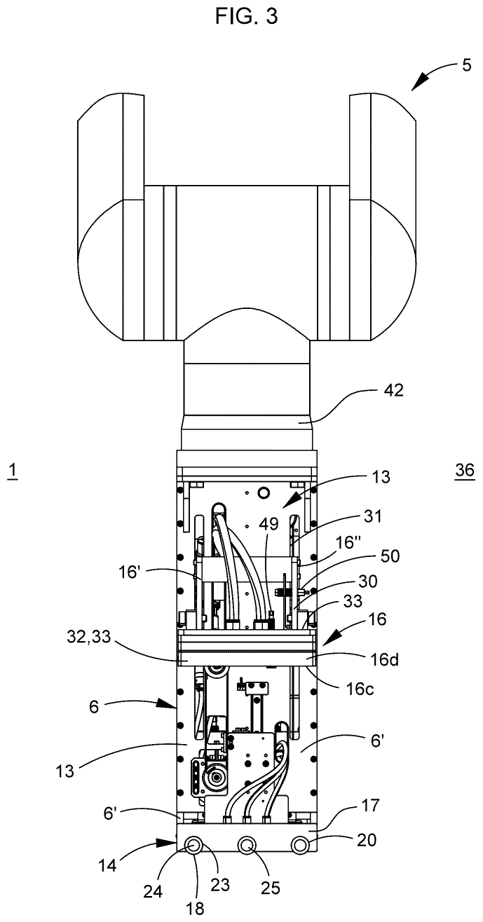

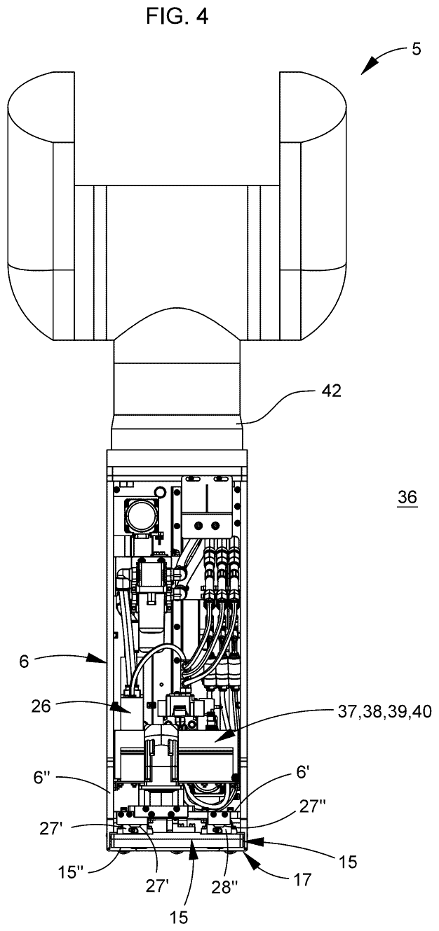

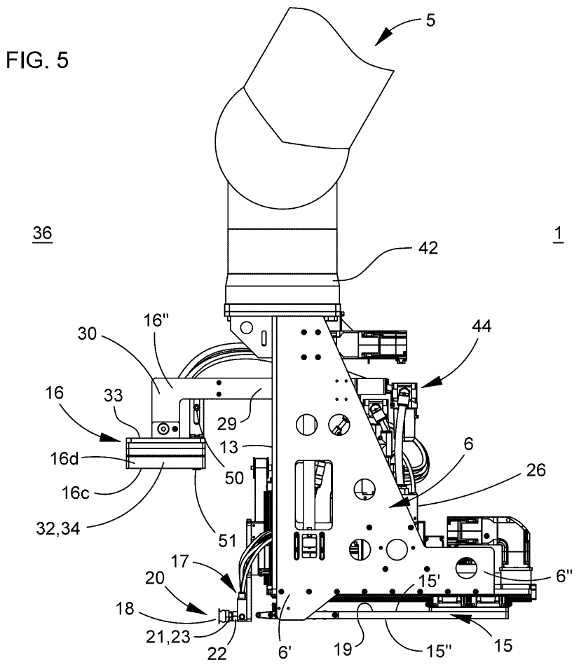

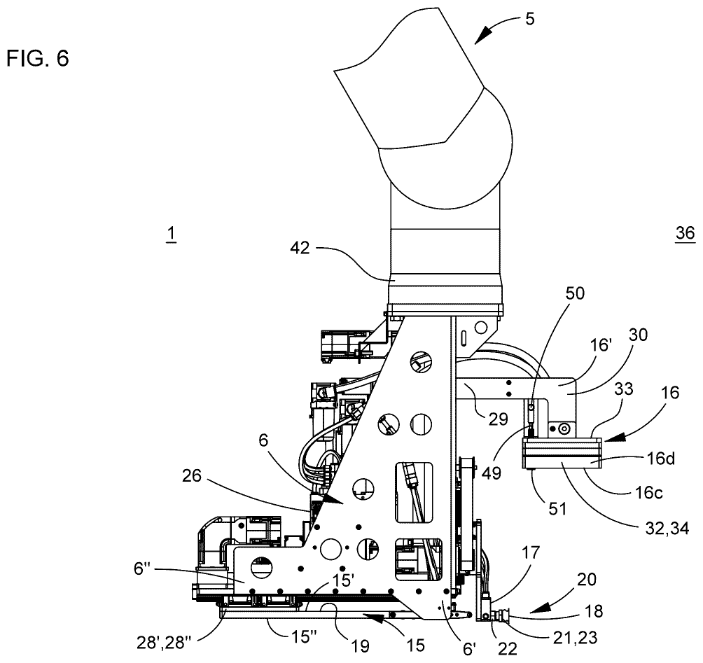

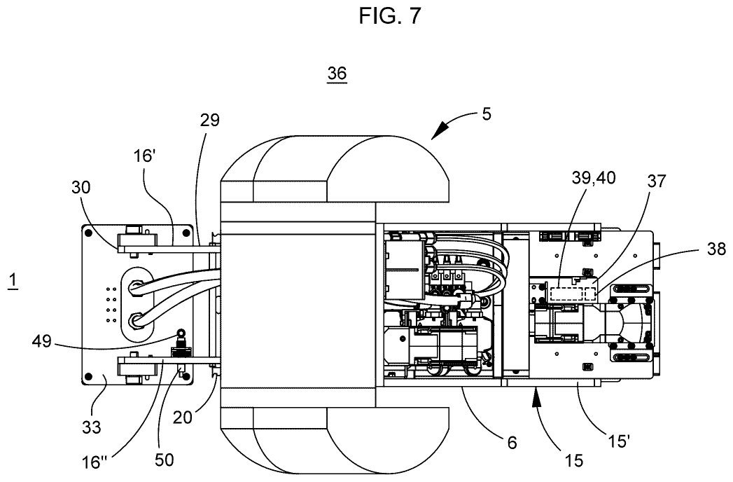

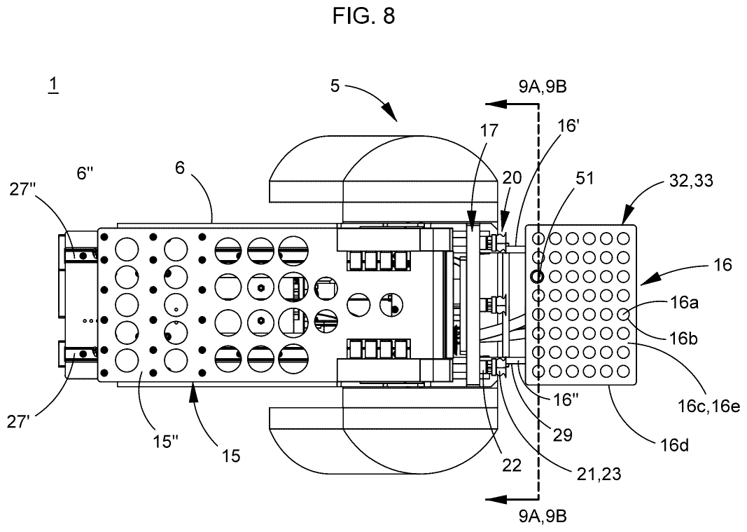

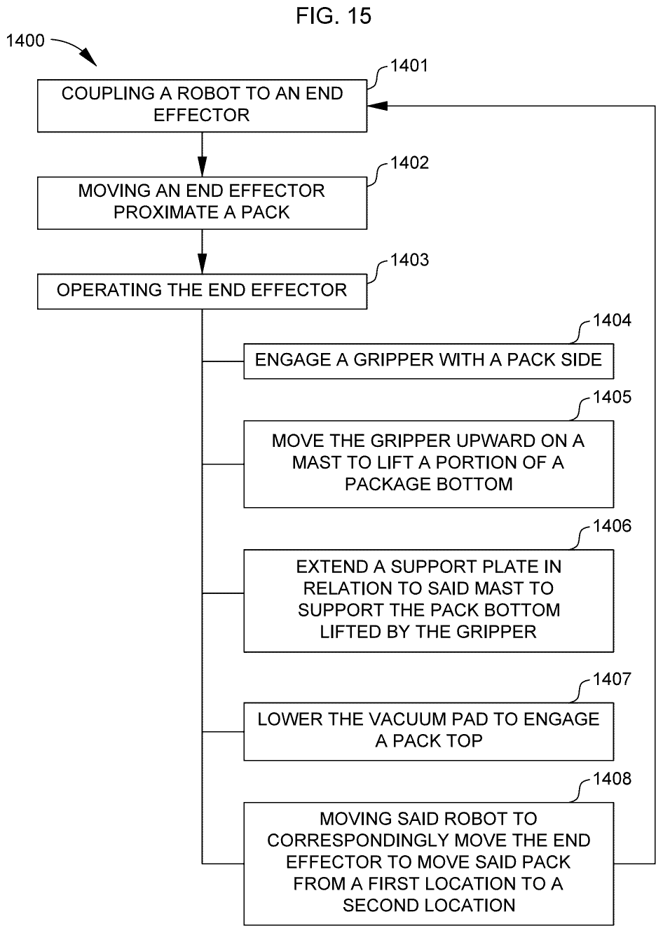

Generally, referring to FIGS. 1 through 15, which depict a particular embodiment of an inventive end effector (1), a method of making an inventive end effector (1) and a method of using an inventive end effector (1) to engage and move an object (2) from a first location (3) to a second location (4).

An end effector (1) comprises a peripheral device that can be attached to a movement mechanism (5), such as an automaton or a robot, to perform a task. The inventive end effector (1) can comprise an electromechanical device configured to engage an object (2) and move the object (2). The end effector (1) can include a framework (6) that operatively supports components of the end effector (1) in a configuration to engage an object (2) for movement by the movement mechanism (5). The illustrative example of an object (2) depicted in the Figures comprises a case or a carrier tray containing an accumulation of products (referred to as “a pack” (7)) stacked on a pallet (8); however, the term object (2) is not intended to be limited solely to cases or carrier trays, and a pack (7) can be any item having one or more of: a pack top (9), a pack bottom (10) and a pack side (11). The recitation of move an object (2) from a first location (3) to a second location (4) should be broadly construed as any movement of the object (2), and can include movement that separates a first object (2′) a distance from another object (2″), and specifically includes movement of the end effector (1) to separate a first pack (7′) a distance from a second pack (7″), or a first pack (7′) from stack of packs (7′″). As examples, the end effector (1) can move a first pack (7′) from a stack of packs (7′″) on a first pallet (8′) to stack of packs (7′″) on a second pallet (8″), or to a conveyor for sorting, or to a stationary surface.

Now, with primary reference to FIGS. 1 through 8, a particular embodiment of the inventive end effector (1) can include a framework (6) including an upright mast (13) which supports operation of one or more of: a vacuum pad (16) movably coupled to the upright mast (13), a vacuum gripper (14) movably coupled to the upright mast (13), a support plate (15) retractably extendable in relation to the upright mast (13). The upright mast (13) can be adapted or configured to guide the upward and downward motion of the vacuum pad (16) and the vacuum gripper (14) along the upright mast (13). The support plate (15) can be slidably coupled to the framework (6) and can be retractably extended below the vacuum gripper (14), and as shown in the illustrative examples, in substantially orthogonal relation to the upright mast (13).

Again, with primary reference to FIGS. 1 through 8, embodiments of the vacuum gripper (14) can be coupled to a gripper body (17) configured to movably couple to the upright mast (13) for upward and downward movement of the vacuum gripper (14) along the upright mast (13). The vacuum gripper (14) can be configured to afford a vacuum gripper face (18) configured to grip an object (2) or pack (7). The particular embodiment of the vacuum gripper (14) depicted in the Figures, includes one or more gripper cups (20). The one or more gripper cups (20) comprise a gripper cup annular side wall (21) extending from a gripper cup bottom (22) to the vacuum gripper face (18). The gripper cup annular sidewall (21) can have a thickness disposed between a gripper cup annular sidewall external surface (23) and a gripper cup annular sidewall internal surface (24) defining a cup interior space (25). The one or more gripper cups (20) can be elastic both in radial and in axial direction and therefore can offer conformable engagement of the vacuum gripper face (18) with the object (2) or pack side (11) of a pack (7). In particular embodiments, the gripper cup (20) can enclose the cup interior space (25) adapted to or configured to fluidically couple to a vacuum source (26). The vacuum source (26) can be operated to draw a vacuum at the vacuum gripper face (18), and in the particular embodiment shown in the Figures, within a cup interior space (25) of the one or more gripper cups (20). While the gripper cups (20) depicted in the Figures have an circular configuration at the vacuum gripper face (18); this illustrative example is not intended to preclude other configurations of the gripper cups (20) which may have oval, square, rectangular or other geometry of the vacuum gripper face (18) capable of engaging an object (2) or pack (7) with sufficient frictional force and/or suction forces to move the object (2) or pack (7) as the gripper body (17) moves vacuum gripper (14) upward or downward along the upright mast (13).

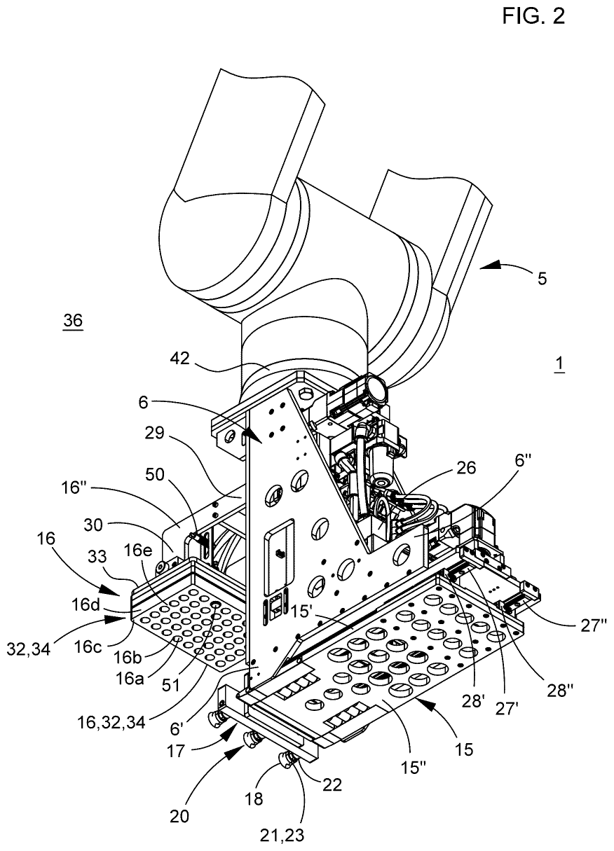

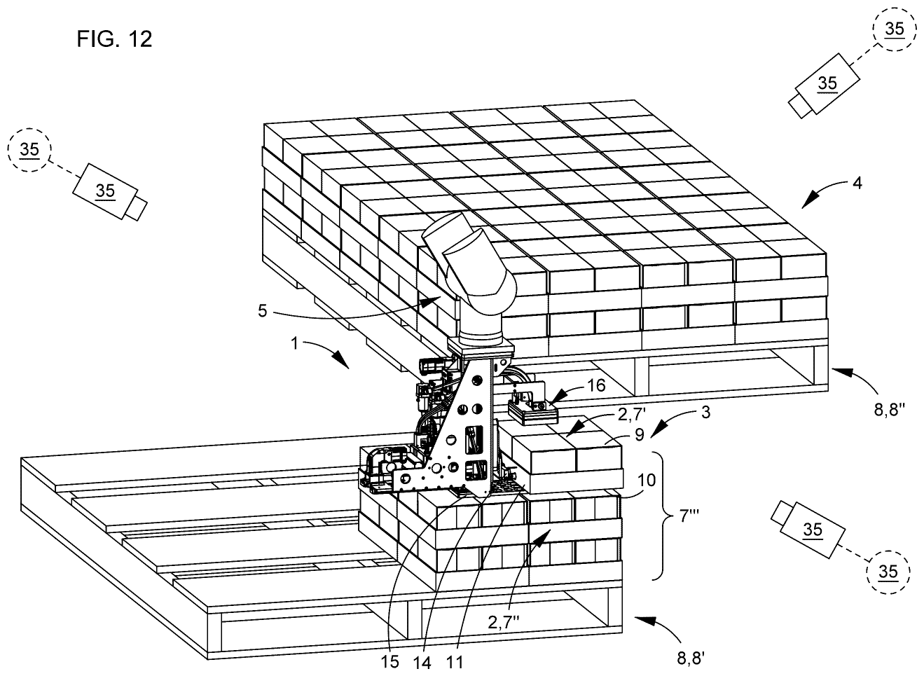

Again, with primary reference to FIGS. 1 through 8, embodiments of the support plate (15) retractably extendable in relation to the upright mast (13) can include a plate first side (15′) opposite plate second side (15″). The plate first side (15′) and the plate second side (15′) can be configured to be disposed between a pair of packs (7′, 7″) stacked on a pallet (12). The plate first side (15′) can have a support plate face (19) configured to engage a pack bottom (10) (as shown in the example of FIG. 12). A suitable configuration of the support plate (15) can include a plate first side (15′) facing the framework (6) being substantially flat over the portion extendable outward of the mast (13) and the plate second side (15″) facing away from the framework (6) being substantially flat; however, the plate first side (15′) and the plate second side (15″) can be configured to the particular geometry of the packs (7). The plate first side (15′) can be slidably mounted to the framework (6), and in the embodiment depicted, includes a pair of tracks (27′, 27″) disposed in parallel relation extending along the bottom of the framework (6) between the framework front end (6′) to the framework back end (6″) (as shown in the example of FIG. 2). Track followers (28′, 28″) coupled to the plate first side (15′) are configured to correspondingly slidably secure to the pair of tracks (27′, 27″). The track followers (28′, 28″) can slide in reciprocal direction along the pair of tracks (27′, 27″) to correspondingly extend and retract the support plate (15) in relation to the mast (13). In particular embodiments, the pair of tracks (27′, 27″) and corresponding track followers (28′, 28″) can comprise liner bearing slide rails, a pair of rods and corresponding linear bearings, or T-tracks and corresponding T-slides.

Now, with primary reference to FIGS. 1 through 8, embodiments can include one or more vacuum pad arms (16′, 16″) configured to movably couple a vacuum pad (16) to the upright mast (13). The vacuum pad arm(s) (16′, 16″) outwardly extend from the upright mast (13) to dispose the vacuum pad (16) outward of the vacuum gripper face (18) of the vacuum gripper (18). The vacuum pad arm(s) (16′, 16″) can include a vacuum pad arm first end (29) configured to couple to the upright mast (13) for upward and downward movement of the vacuum pad (16) along the upright mast (13) opposite a vacuum pad arm second end (30) terminating sufficiently forward of the mast (13) to dispose the vacuum pad (16) over a pack top (9) when the vacuum gripper (14) engages the pack side (11). In the embodiment depicted, the vacuum pad arm first end (29) comprises a mounting plate (31) adapted to or configured to slidingly engage the upright mast (13) with a pair of vacuum pad arms (16′, 16″) extending outward from the mast (13) terminating in the vacuum pad arm second end (30) including a rigid base (33). The vacuum pad (16) can be coupled to the rigid base (33).

Again, with primary reference to FIGS. 1 through 8, the vacuum pad (16) can include a plurality vacuum pad channels (16a) terminating in a corresponding plurality of vacuum pad channel orifices (16b) open in spaced apart relation on the vacuum pad face (16c). The plurality of vacuum pad channels (16a) can be fluidically coupled to a vacuum source (26) adapted to draw a partial vacuum at the plurality of vacuum channel orifices (16b). The vacuum pad (16) including the plurality of vacuum pad channels (16a) fluidically coupled to a vacuum source (26) adapted to draw a partial vacuum at the plurality of vacuum channel orifices (16b) can comprise in whole or in part a compressible material (32) adapted to compress upon engaging the pack top (9). The compressible material (32) upon engaging the pack top (9) can compress to conform to the geometry of the pack top (9). In particular embodiments, the compressible material (32) can comprise a layer of compressible elastomer or compressible foam (34) secured to the rigid base (33). The term “compressible” means capable of or adapted to be forced into less space. As an illustrative example, the vacuum pad depicted in the Figures can compress up to 0.70 inches (about 18 millimeters).

In particular embodiments, the vacuum pad (16) can comprise a plurality of interchangeable vacuum pads (16) each having the vacuum pad face (16c) extending to a vacuum pad periphery (16d) which delimits a lesser or greater vacuum pad face area (16e). The useful range of the vacuum pad face area (16e) for the methods of use described herein is about 40,000 mm² to about 50,000 mm². However, the general structure of the inventive end effector (1) may be employed in other methods and environments utilizing a vacuum pad (16) having a vacuum pad face area (16e) which may be substantially less than 40,000 mm² or substantially greater than 50,000 mm². A plurality of vacuum pad channel orifices (16b) can open in spaced apart relation on the vacuum pad face (16c). As illustrative examples, a vacuum pad face (16c) of about 40,000 mm² can include about 40 to about 50 vacuum pad channel orifices (16b) and a vacuum pad face area (16c) of about 50,000 mm² can include about 45 to about 60 vacuum pad channel orifices (16b). The plurality of vacuum pad orifices (16b) can be spaced apart in a generally uniform pattern. As an illustrative example, a vacuum pad periphery (16d) delimiting a rectangular vacuum pad face (16c), can dispose the plurality vacuum pad orifices (16b) in columns and rows on the vacuum pad face (16c) where the vacuum pad orifices (16b) are spaced apart by about 20 mm to about 30 mm. However, this example is not intended to preclude embodiments of the vacuum pad (16) having a vacuum pad periphery (16d) delimiting other geometric forms of the vacuum pad face area (16e) including as examples: square, circular, oval, stadium, trapezoid, diamond, or other regular or irregular forms. The Figures provide the illustrative example of a vacuum pad periphery (16c) delimiting a rectangular vacuum pad face (16c) which in the context of a plurality of interchangeable vacuum pads (16) can delimit a corresponding range of vacuum pad face areas (16c) delimited by the corresponding vacuum pad periphery (16d) dimensions of: 235 mm×170 mm×50 mm, 235 mm×200 mm×50 mm, and 245 mm×200 mm×50 mm.

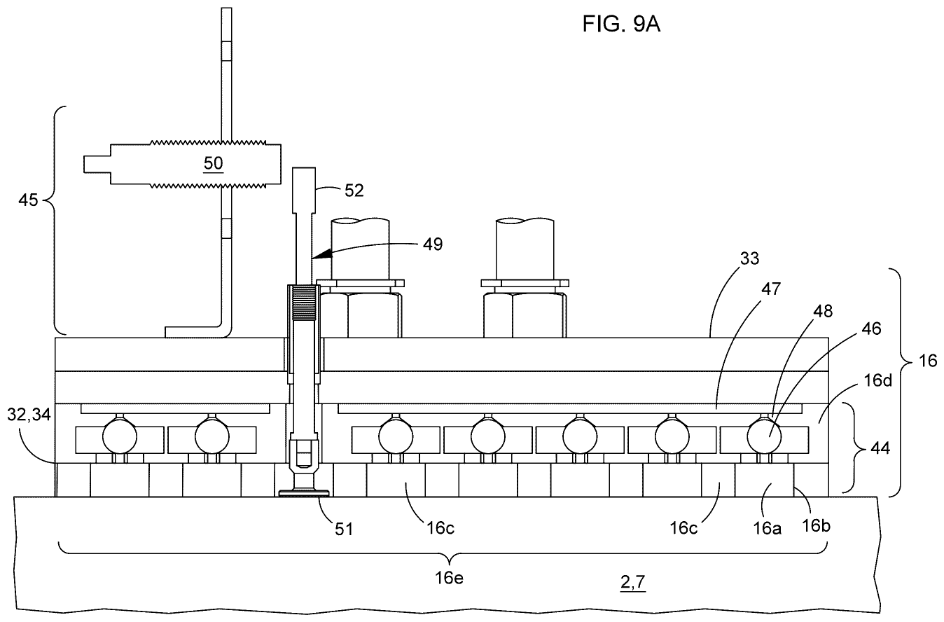

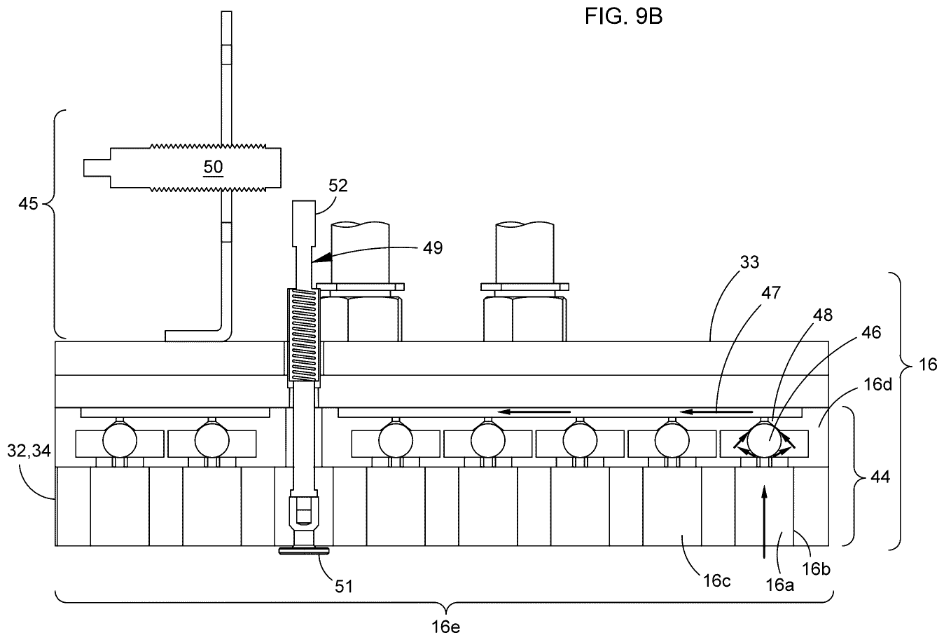

Now, with primary reference to FIGS. 9A and 9B, embodiments of the vacuum pad (16) can further include a vacuum shut-off valve (44) and a pack detection sensor (45). The vacuum shut-off valve (44) shuts off vacuum to the plurality vacuum pad channels (16a) when the vacuum pad (16) is not engaged with a pack (7). A vacuum shut-off valve (44) suitable for use with embodiments of the end effector (1) includes an internal sphere (46) which moves within an air channel (47) based on the pressure difference between the sphere lower portion and the sphere upper portion. When the vacuum pad face (16c) is not engaged with a pack (7), the pressure difference between the sphere lower portion and the sphere upper portion causes the sphere (46) to rise and sealably engage a valve seat (48) to close the air channel (47) and shutting off the vacuum force to the plurality of vacuum pad orifices (16b). When the vacuum pad face (16b) engages a pack (7), the pressure difference between the sphere lower portion and the sphere upper portion is reduced to the extent that the sphere disengages the valve set (48) and the vacuum force is restored to the plurality of orifices (16b).

The pack detection sensor (45) relies on telescoping movement of a rod (49) in relation to a rod sensor (50). The rod (49) maintains an extended state under the action of an internal spring with a rod first end (51) extending outward of the vacuum pad face (16c). When the rod first end (51) engages a pack (7), the internal spring compresses and the rod (49) telescopingly moves to a retracted state and the rod second end (52) is detected by the rod sensor (50) indicating that the vacuum pad face (16) is engaged with a pack (7). If the vacuum pad face (16c) is not engaged with a pack (7), or that the pack (7) has disengaged from the vacuum pad face (16c), the rod sensor (50) is not triggered, indicating that the vacuum pad face (16c) is not engaged with a pack (7) or the pack (7) has disengaged from the vacuum pad face (16c).

Again, with primary reference to FIGS. 1 through 14, the movement mechanism or robot (5) and the end effector (1) can include one or more navigation sensors (35) to sense the position of the movement mechanism or robot (5) and the end effector (1) in the environment (36), and in particular, the spatial orientation of one or more of: the end effector (1) to a pack (7) to allow orientation of the vacuum gripper (14) in relation to the pack side (11), the orientation of the support plate (15) relative to the mast (13) and relative to the pack bottom (10), and the orientation of the vacuum pad (16) in relation to the pack top (9). The navigation sensors (35) can include one or more of: an image sensor (camera), an infrared sensor (infrared camera), an accelerometer, capacitive or capacitive displacement sensors, inductive sensors, magnetic, photoelectric sensors, reflectivity sensors, laser-range finder sensors, infrared sensors, charge coupled sensors, radar sensors, ultrasonic sensors, fiber optics sensor, hall effect sensors, touch switch, or combinations thereof. As an illustrative example, a navigation sensor (35) can comprise a plurality of camaras (35) to sense the position of the end effector (1) in the environment (36) and in spatial relation to the pack top (9) or the position of the vacuum pad (16) in spatial relation to the pack top (9).

Again, with primary reference to FIGS. 1 through 14, the inventive end effector (1) can be under control of a controller (37) including a processor (38) communicatively coupled to a non-transitory computer readable media (39) containing a program code (40). The controller (37) can be external and communicatively coupled to the movement mechanism or robot (5) or end effector (1) or can be internal to the movement mechanism or robot (5) or the end effector (1) or be distributed as both external and internal components communicatively coupled to the movement mechanism or robot (5) or the end effector (1). The controller (37) can receive and process input navigation sensor signals (41) from the one or more navigation sensors (35) and generate output control signals (43) that enable the movement mechanism or robot (5) and the end effector (1) to operate within the environment (36) to perform a task, and in particular, the methods of using the end effector (1) to move a pack (7).

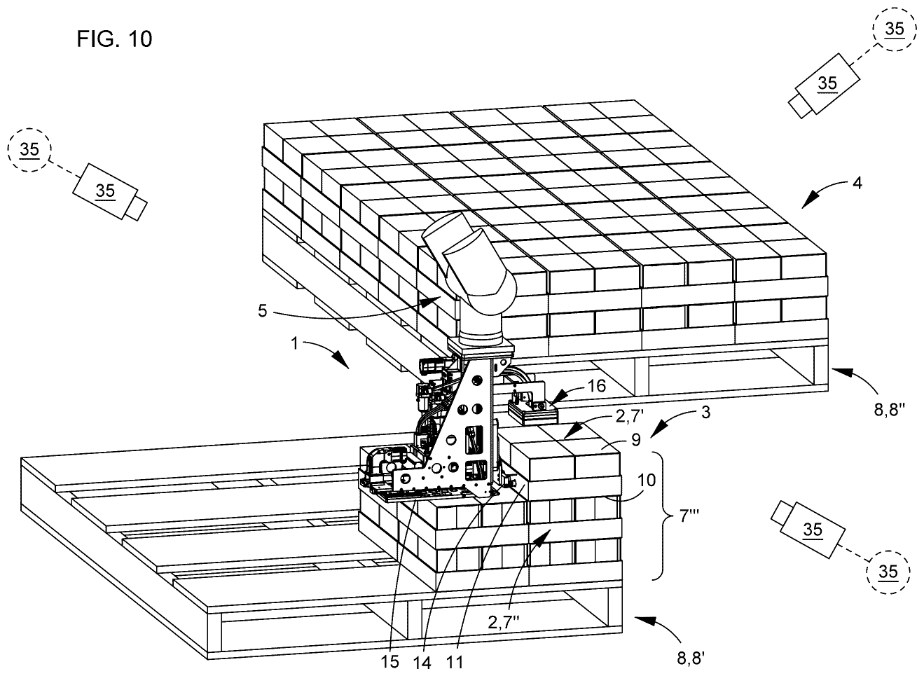

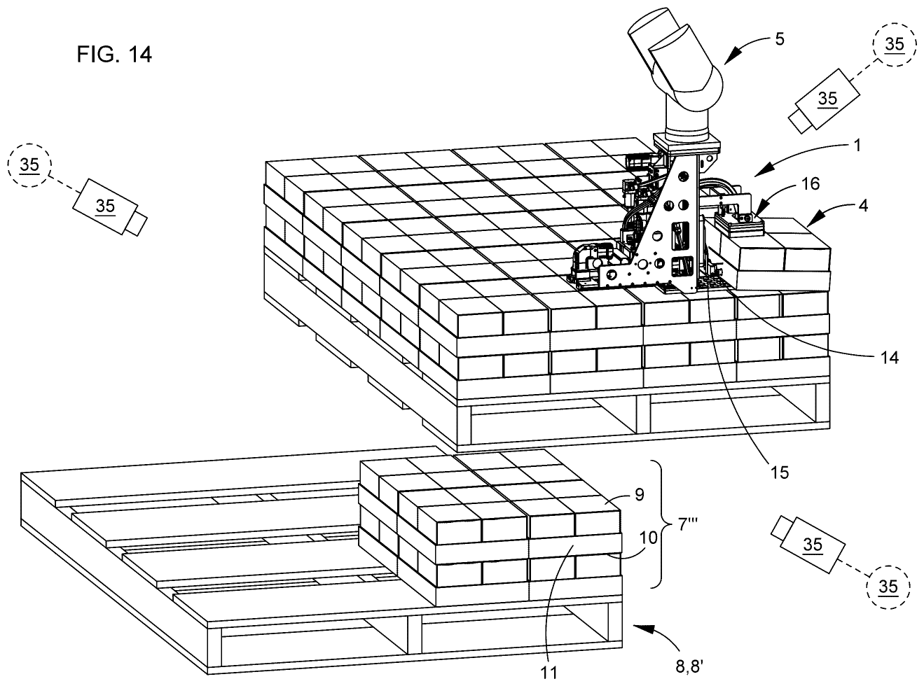

Now, with primary reference to FIGS. 10 through 15, an illustrative method of using particular embodiments of the inventive end effector (1) is shown (Block Flow Diagram 1400). The method can include one more of the following, although the stepwise order may differ depending on the particular application. The method can include coupling the movement mechanism or robot (5) to the end effector (1) (as shown in FIG. 9 and FIG. 14 Block 1401). Typically, the mechanical interface (42) between the movement mechanism or robot (5) and the end effector (1) comprises two mating parts designed to couple together and pass utilities such as one or more of: controller output and input signals, electrical utilities, pneumatic utilities, liquids, or the like. In particular embodiments the mechanical interface (42) can be locked to behave as a rigid mechanical interface (42) during motion of the robot (5) and can be a compliant mechanical interface (42) having sufficient degrees of freedom during constrained motion of the end effector (1) to perform a task. The method can further include moving the end effector (1) proximate a pack (7) or a stack of packs (7′″) (as shown in FIG. 9 and FIG. 14 Block 1402).

The method can further include operating the end effector (1) (as shown in FIGS. 9 through 14 Block 1403 including one or more of Blocks 1404 through 1408). The method can further include engaging the vacuum gripper (14) with a pack side (11) (as shown in FIG. 9 and FIG. 14 Block 1404). Engaging the vacuum gripper (14) with a pack side (11) can comprise one or more of engaging a vacuum gripper face (18) with the pack side (11), or can comprise engaging one or more vacuum gripper cups (20) to a pack side (11), or can comprise engaging one or more vacuum gripper cups (20) to a pack side (11) with or without generating a partial vacuum in the one or more gripper cups (20). Thus, the engagement of the vacuum gripper (14) with the pack side (11) can be solely frictional engagement without vacuum or can be engagement of the vacuum gripper (14) with vacuum to enhance engagement, or combinations thereof. The method can further include moving the vacuum gripper (14) upward along the mast (13) (as shown in FIG. 10 and FIG. 14 Block 1405). The movement of the gripper (14) upward along the mast (13) can reduce the load exerted between a first pack and a second pack (7′, 7″) in a stack of packs (7′″) (or a pack and another surface), or can lift a portion of a first pack (7′) in stack of packs (7′″) upward from a second pack (7″) in the stack of packs (7′″). In particular embodiments, a portion of the first pack (7′) in a stack of packs (7′″) can be lifted away from the second pack (7″) in the stack of packs (7″′) (or away from another surface).

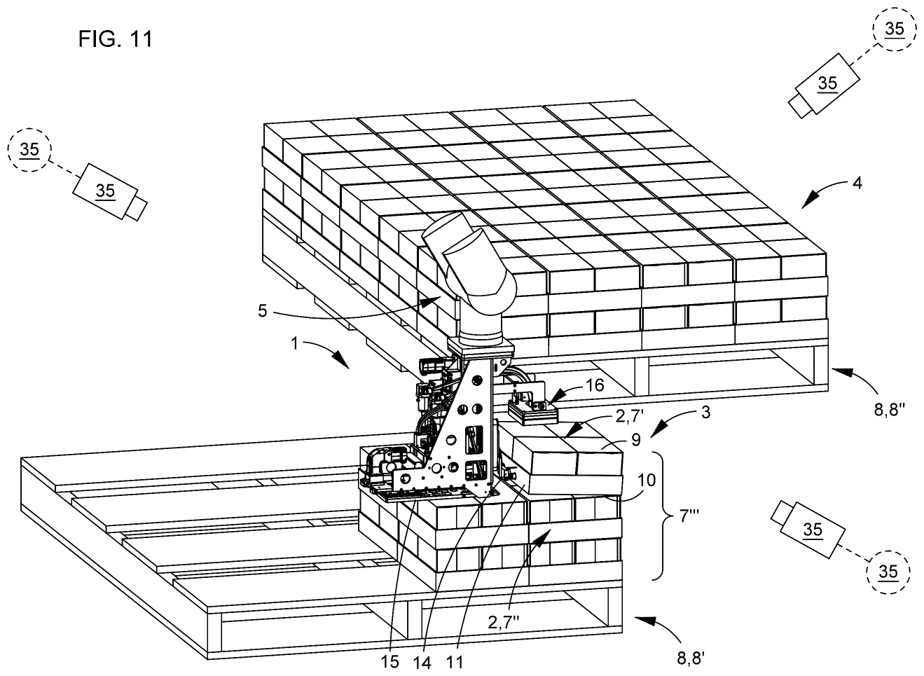

The method can further include extending a support plate (15) in relation to the mast (13) to a position between the first pack (7′) in the stack of packs (7′″) and the second pack (7″) in the stack of packs (7′″) (or other surface) (as shown in FIG. 11 and FIG. 24 Block 1406). The support plate (15) can be positioned to support the pack bottom (10).

The method can further include lowering the vacuum pad (16) to engage the pack top (11) of the pack (7) (as shown in FIG. 12 and FIG. 14 Block 1407). Engaging the pack top (10) of the pack (7) can comprise one or more of engaging a vacuum pad arm second end (30) of the one or more vacuum pad arms (16′, 16″) to the pack top (10) or engaging a vacuum pad (16) coupled to the one or more vacuum pad arm(s) (16′, 16″) to the pack top (10) or engaging a vacuum pad (16) comprised of a compressible material (32) to the pack top (10). The vacuum pad (16) including the compressible material (32) may compress to conform in whole or in part to the surface of the pack top (10). Depending upon the application, the method may only include lowering the vacuum pad (16) to engage the pack top (11) of the pack (7) (as shown in FIG. 12 and FIG. 14 Block 1407), or may only include first lowering the vacuum pad (16) to engage the pack top (11) of the pack (7) (as shown in FIG. 12 and FIG. 14 Block 1407), and second engaging the vacuum gripper (14) with a pack side (11) (as shown in FIG. 9 and FIG. 14 Block 1404), or may include first lowering the vacuum pad (16) to engage the pack top (11) of the pack (7) (as shown in FIG. 12 and FIG. 14 Block 1407), and second engaging the vacuum gripper (14) with a pack side (11) (as shown in FIG. 9 and FIG. 14 Block 1404), and third extending a support plate (15) in relation to the mast (13) to a position between the first pack (7′) in the stack of packs (7′″) and the second pack (7″) in the stack of packs (7′″) (or other surface) (as shown in FIG. 11 and FIG. 24 Block 1406).

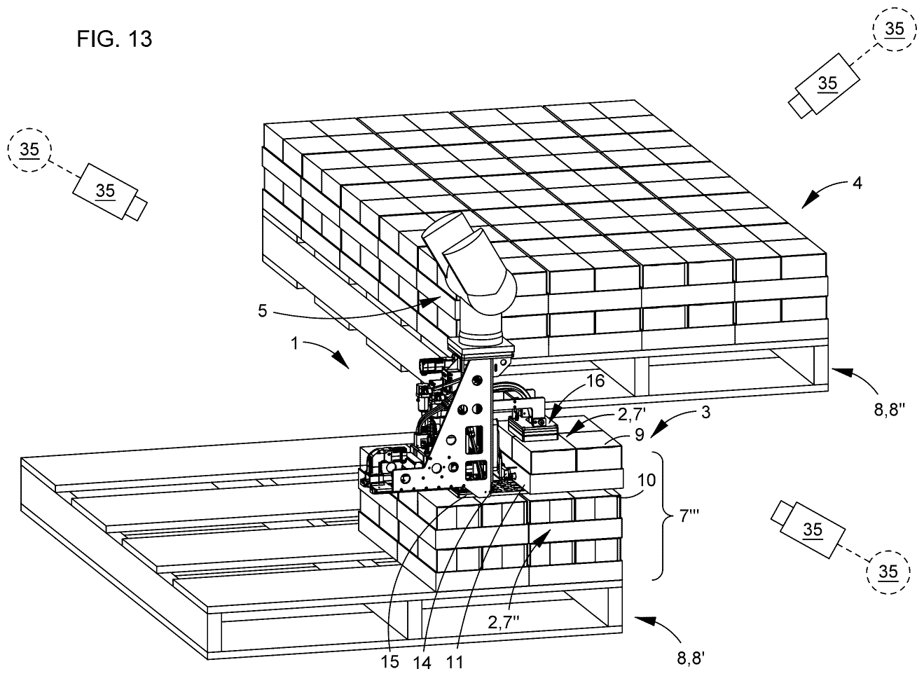

The method can further include moving the movement mechanism or robot (5) to correspondingly move the end effector (1) to move the pack (7) from a first location (3) to a second location (4) (as shown in FIG. 13 and FIG. 14 Block 1408).

As can be easily understood from the foregoing, the basic concepts of the present invention may be embodied in a variety of ways. The invention involves numerous and varied embodiments of an end effector (1) and methods for making and using such end effector (1) including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “gripper” should be understood to encompass disclosure of the act of “gripping”—whether explicitly discussed or not—and, conversely, were there is a disclosure of the act of “gripping”, such a disclosure should be understood to encompass disclosure of a “gripper” and even a “means for gripping”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the end effectors herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

I claim:

1. An end effector, comprising:
an upright mast;
a vacuum pad movably coupled to said upright mast, said vacuum pad having a vacuum pad face configured to engage a pack top;
a vacuum gripper movably coupled to said upright mast, said vacuum gripper having a vacuum gripper face configured to engage a pack side; and
a support plate extendable in relation to said upright mast, said support plate having a support plate face configured to engage a pack bottom.

2. The end effector of claim 1, wherein said end effector having said vacuum pad face engaged to said pack top and said support plate face engaged to a pack bottom adapted to move said pack from a first location to a second location.

3. The end effector of claim 1, further comprising a vacuum pad arm configured to movably couple said vacuum pad to said upright mast, said vacuum pad arm disposes said vacuum pad outward of said vacuum gripper face.

4. The end effector of claim 1, wherein said vacuum pad includes a plurality vacuum pad channels terminating in a corresponding plurality of vacuum pad channel orifices open in spaced apart relation on said vacuum pad face, wherein said plurality of vacuum channels fluidically coupled to a vacuum source adapted to draw a partial vacuum at said plurality of vacuum channel orifices.

5. The end effector of claim 4, wherein said vacuum pad comprises a compressible material adapted to compress upon engaging said pack top.

6. The end effector of claim 5, wherein said vacuum pad face extends to a vacuum face periphery delimiting a vacuum pad face area of about 40,000 mm² to about 50,000 mm².

7. The end effector of claim 1, wherein said vacuum gripper includes a plurality of cups each having an internal surface which defines an interior space fluidically coupled to a vacuum source adapted to draw a partial vacuum in said interior space of said one or more cups.

8. The end effector of claim 7, wherein said vacuum gripper having said vacuum gripper face engaged to said pack side adapted to move upward on said mast to lift said pack side.

9. The end effector of claim 8, wherein said support plate having said support plate face engaged to said pack bottom adapted to support said pack.

10. The end effector of claim 2, wherein said first location comprises a first pallet containing a plurality of packs, and wherein said second location comprises a second pallet configured to receive one or more of said plurality of packs.

11. The end effector of claim 1, wherein said pack comprises a case or a carrier tray.

12. The end effector of claim 11, wherein said carrier tray comprises a cardboard carrier tray having a carrier tray bottom and interconnected upwardly extending carrier tray sides.

13. A method of making an end effector, comprising:
providing an upright mast;
movably coupling a vacuum pad to said upright mast, said vacuum pad having a vacuum pad face configured to engage a pack top;
movably coupling a vacuum gripper to said upright mast, said vacuum gripper having a vacuum gripper face configured to engage a pack side; and
extendably retractably coupling a support plate in relation to said upright mast, said support plate having a support plate face configured to engage a pack bottom.

14. The method of claim 13, wherein said end effector having said vacuum pad face engaged to said pack top and said support plate face engaged to a pack bottom adapted to move said pack from a first location to a second location.

15. The method of claim 13, further comprising configuring a vacuum pad arm to movably couple said vacuum pad to said upright mast, said vacuum pad arm disposes said vacuum pad outward of said vacuum gripper face.

16. The method of claim 13, further comprising:
disposing a plurality vacuum pad channels in said vacuum pad, said plurality of vacuum pad channels terminating in a corresponding plurality of vacuum pad channel orifices open in spaced apart relation on said vacuum pad face; and
fluidically coupling said plurality of vacuum channels to a vacuum source adapted to draw a partial vacuum at said plurality of vacuum channel orifices.

17. The method of claim 16, producing said vacuum pad from a compressible material adapted to compress upon engaging said pack top.

18. The method of claim 16, further comprising extending said vacuum pad face to a vacuum face periphery delimiting a vacuum pad face area of about 40,000 mm² to about 50,000 mm².

19. The method of claim 13, further comprising:
configuring said vacuum gripper as plurality of cups each having an internal surface which defines an interior space; and
fluidically coupling said interior space of said plurality of cups to a vacuum source adapted to draw a partial vacuum in said interior space of said plurality of cups.

20. The method of claim 19, further comprising adapting said plurality of cups to engage said pack side and move upward on said upright mast to lift said pack side.

21. The end effector of claim 20, further comprising adapting said support plate having said support plate face engaged to said pack bottom to support said pack.

22. The method of claim 14, wherein said first location comprises a first pallet containing a plurality of packs, and wherein said second location comprises a second pallet configured to receive one or more of said plurality of packs.

23. The end effector of claim 13, wherein said pack comprises a case or a carrier tray.

24. The end effector of claim 23, wherein said carrier tray comprises a cardboard carrier tray having a carrier tray bottom and interconnected upwardly extending carrier tray sides.
